(19) United States
(12) Patent Application Publication
(10) Pub. No.: US 2026/0086875 A1
(43) Pub. Date: Mar. 26, 2026

(54) Worker Pool Management for Achieving Quality of Service Background

(71) Applicant: Rakuten Mobile, Inc., Tokyo (JP)

(72) Inventors: Sree Nandan Atur, San Mateo, CA (US); Nikita Joanne Raj, San Mateo, CA (US)

(21) Appl. No.: 18/898,254

(22) Filed: Sep. 26, 2024

(51) Int. Cl. G06F 9/50

(52) U.S. Cl. CPC G06F 9/5072; G06F 9/5038; G06F 9/5044

(57) ABSTRACT

A network environment is configured to provide a worker pool and receive a workflow including a plurality of tasks, the plurality of tasks including one or more groups of parallelizable tasks. The network environment further receives a quality of service for the workflow and executes the workflow with workers from the worker pool while creating workers to execute a number of the one or more groups of parallelizable tasks in parallel effective to achieve the quality of service and while deleting workers when not executing the one or more groups of parallelizable tasks.

### BACKGROUND

### Field of the Invention

The present disclosure relates to managing worker pools for achieving a quality of service.

### Background of the Invention

The information disclosed in this background section is only for enhancement of understanding of the general background of the disclosure and should not be taken as an acknowledgement or any form of suggestion that this information forms the prior art already known to a person skilled in the art.

In a large entity operating a large number of servers or a large number of software instances in a cloud, many tasks in the lifecycle of a software instance must be performed repeatedly. Efficient operation may require that some tasks be performed in a predictable time frame.

It would be an advancement in the art to improve the lifecycle management of software instances in complex systems.

### SUMMARY OF THE INVENTION

A system includes a network environment comprising a plurality of computing devices and a network connected to the plurality of computing devices. The network environment is configured to provide a worker pool and receive a workflow including a plurality of tasks, the plurality of tasks including one or more groups of parallelizable tasks. The network environment further receives a quality of service for the workflow. The network environment executes the workflow with workers from the worker pool while creating workers to execute a number of the one or more groups of parallelizable tasks in parallel effective to achieve the quality of service and while deleting workers when not executing the one or more groups of parallelizable tasks.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a network environment in which workflows may be executed in accordance with an embodiment;

FIG. 2 is a schematic block diagram of a system for implementing a worker pool in accordance with an embodiment of the present disclosure;

FIG. 3 is a schematic diagram of a workflow in accordance with an embodiment of the present disclosure;

FIG. 4 is a process flow diagram of a method for predicting timing out of a queued workflow in accordance with an embodiment;

FIG. 5 is a process flow diagram of a method for managing a worker pool according to a quality of service in accordance with an embodiment; and

FIG. 6 is a schematic block diagram of an example computing device suitable for implementing methods in accordance with embodiments of the disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more. ” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

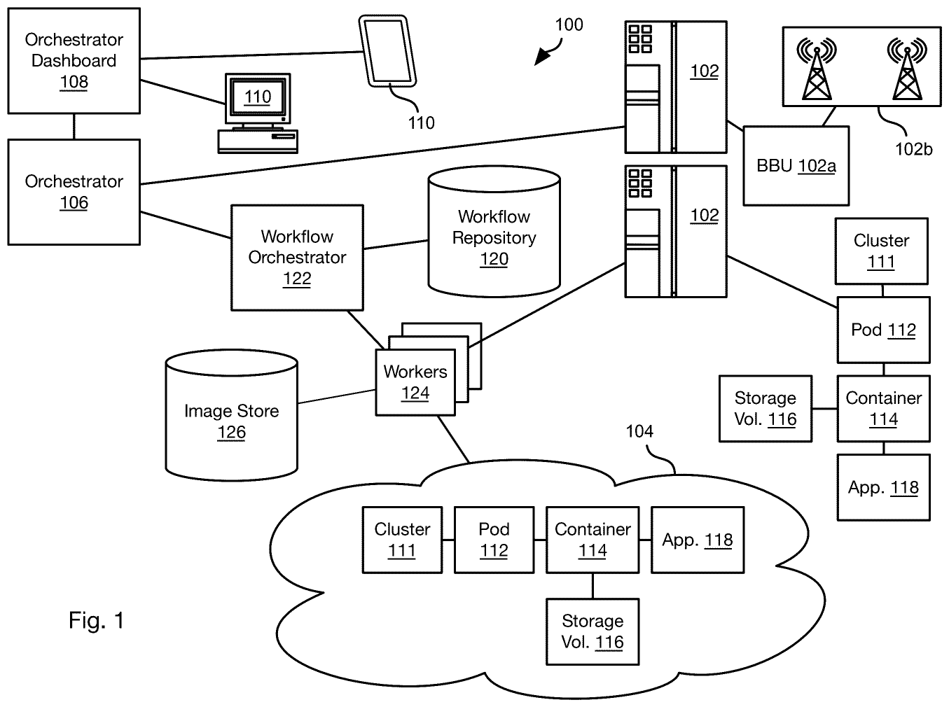

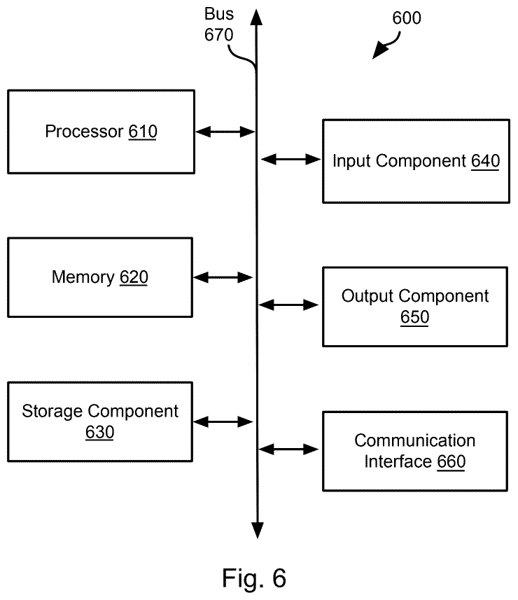

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 600 of FIG. 6.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform.

In some embodiments, some or all of the servers 102 may function as edge servers in a telecommunication network. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.). Servers 102 that function as edge servers may have limited computational resources or may be heavily loaded.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down the number of application instances 118.

An orchestrator 106 may execute on a computer system that is distinct from the servers 102 and is connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QoS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions. Workflows may be predefined and stored in a workflow repository 120. A workflow may be defined to perform various tasks in a lifecycle of a software component. For example, a workflow may instantiate each type of component (cluster 111, pod 112, container 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 may retrieve the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

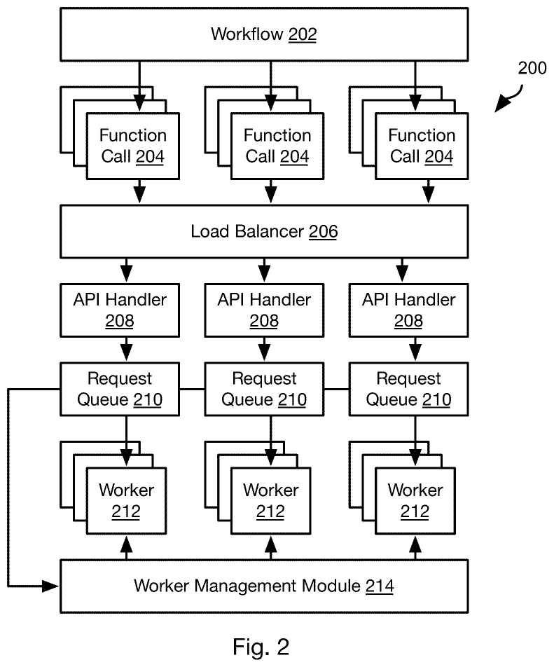

FIG. 2 illustrates a system 200 for processing a workflow 202, such as a workflow as described above with respect to the workflow repository 120. However, a workflow 202 may be executed according to the approach described below independent of the workflow repository 120 and in network environments other than the network environment 100.

A workflow 202 may include a series of tasks that may be invoked by generating a function call 204. The function calls 204 may be application programming interface (API) calls.

The function calls 204 may be input to a load balancer 206 that distributes the function calls to one or more API handlers 208. The load balancer 206 may implement any load balancing approach known in the art, such as round robin, in order to implement priority or fairness criteria.

Each API handler 208 then adds the function calls 204 it receives to a request queue 210. The API handler 208 may add the function calls 204 to the queue 210 in order to enforce a rate limit, role-based access control (RBAC), quotas, or other policies. For example, the API handler 208 may add function calls 204 to the request queue 210 according to policies applied to the properties of the function calls 204 received by the API handler 208. For example, function calls 204 from a particular user may be subject to a rate limit (e.g., number of function calls per minute) such that function calls 204 will be throttled and added to the queue 210 at a rate no faster than that rate limit.

One or more workers 212 may be associated with each request queue 210 and select items from the queue 210 for processing, such as workers 212 having some or all of the attributes of the workers 124 described above. Function calls 204 in a queue 210 may be selected, removed from the queue and executed on a first-in-first out (FIFO) basis. Function calls may have a priority associated therewith. Accordingly, function calls may be selected and removed based on priority and FIFO, i.e., among function calls with the same priority the oldest unexecuted call will be selected when function calls with that priority are being executed. Whether a particular priority is selected for selection of a function call may be determined randomly with the probability of a priority being selected increasing with the value of the priority (e.g., higher priority =more likely to be selected).

Removing function calls 204 from the queue 210 may be performed by pushing function calls 204 to workers 212 or the workers 212 pulling function calls 204 from the queue 210, or a combination of pushing and pulling.

The creation and deletion of the workers 212 may be managed by a worker management module 214. The worker management module 214 may execute on a computing node of a network environment, such as the network environment 100. The worker management module 214 may manage the creation and deletion of workers 212 on multiple nodes of a network environment, including nodes connected by a network to the node on which the worker management module 214 is executing. The multiple nodes may be part of multiple clusters, such as KUBERNETES clusters, defined in the network environment. In other implementations, the worker management module 214 only manages workers 212 on the node executing the worker management module 214.

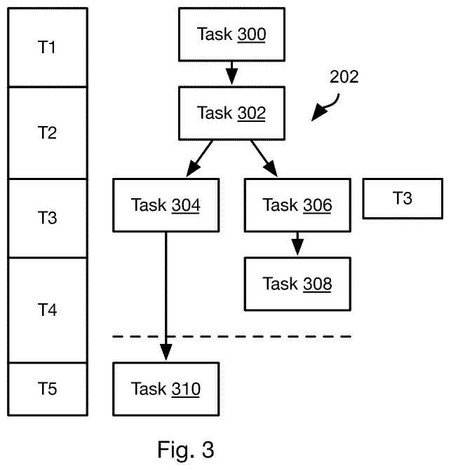

Referring to FIG. 3, a workflow 202 may include a plurality of tasks 300-310 arranged in a directed acyclic graph defining the ordering of the tasks 300-310, permitted parallelism of the tasks 300-310, and possibly other constraints. For example, task 302 follows task 300 according to the workflow, tasks 304 and 306 follow tasks 302 and may be performed in parallel. Task 310 follows task 304 and task 308 follows task 306. However, task 310 is constrained to wait to start until task 308 has completed. There may be any number of tasks in a workflow and any number of relationships among them.

Each task 310 may be a function call 204, collection of function calls, or an action invoked by a function call 204.

In a large network environment, such as the network environment 100, many workflows 202 and the tasks 300-310 of such workflows are performed repeatedly, often on identical or similar hardware. Accordingly, the time required to perform each task 300-310 may be well known, e.g., an average time required to perform the same tasks 300-310, the maximum time, 75^{th} percentile time, or other statistical characterization, may be used as a task runtime. The task runtimes may take into account transition time required to transition from one task to the next.

For the illustrated workflow 202, the time required to execute the workflow (“the workflow runtime”) may be the sum of task runtime T1 for tasks 300, task runtime T2 for tasks 302, task runtime T3 for tasks 304, task runtime T4 for tasks 308, and task runtime T5 for task 310. Task 306 is performed in parallel with task 304 such that the task runtime T3 does not add to the workflow runtime. However, if tasks 304, 306 are not performed in parallel, the task runtime T3 will be added to the workflow runtime.

The workflow runtime can therefore be calculated as a function of the task runtimes as well as the amount of available parallelism, e.g., the number of workers 212 available to execute parallelizable tasks. Stated differently, the workflow runtime with all available parallelism will be increased by the task runtime of each parallelizable task that is instead formed in series with respect to other tasks that could have been performed in parallel with that parallelizable task.

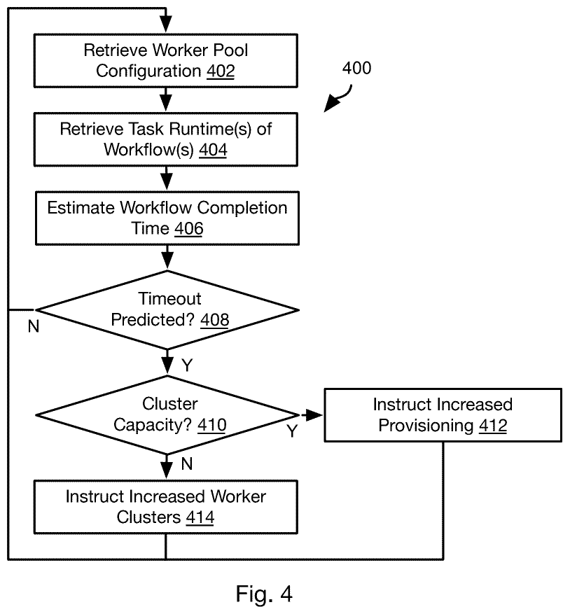

FIG. 4 illustrates a method 400 that may be executed in the network environment 100, such as by the worker management module 214, workflow orchestrator 122, orchestrator 106, or another component.

The method 400 may include retrieving 402 a worker pool configuration. The worker pool configuration may include the number of workers 212. In some embodiments, workers 212 may be specialized such that the worker pool configuration may include a number of workers 212 of each type of worker 212.

The method 400 may include retrieving 404 the task runtimes of the workflows that have tasks currently being executed by the workers 212 and/or have one or more tasks listed in one or more queues 210.

The method 400 may include estimating 406 the workflow completion time of the workflows that have tasks currently being executed by the workers 212 and/or have one or more tasks listed in one or more queues 210. For example, step 406 may include assuming execution in ordering and parallelism defined by each workflow (see FIG. 3) as limited by the number of workers 212 and that each workflow is executed in an order, such as according to priority or order of addition to the queues 210, with each worker 212 beginning execution of another task from a corresponding queue 210 when a preceding task is complete.

The method 400 may include evaluating 408 whether a timeout is predicted for any workflows. A timeout may be predicted for a workflow where the workflow has a completion time that is more than a timeout period after a starting time of execution of the workflow. The timeout period may be, or be derived from, a quality of service (QoS) associated with a user that is the owner of the workflow, e.g., a level of service that the user has paid for. For example, the timeout period may be a reference workflow runtime multiplied by a value X. For example, the reference workflow runtime may be the workflow runtime assuming all possible parallelism is implemented and no waiting for an available worker 212 occurs. The higher the value X, the lower the QoS. For example, the value X may be greater than 1 indicating that serialization of parallelizable tasks and waiting is acceptable, with the amount of waiting and amount of serialization increasing with increase in X. The value may be equal to 1 indicating that no serialization of parallelizable tasks is acceptable and no waiting for other workflows to complete is acceptable. The value of X may be specified by a user that is an owner of a workflow and may be increased or decreased, such as at some point during execution of a workflow.

If any workflows are found at step 408 to have a predicted timeout, the method 400 may include evaluating 410 whether a cluster 111 executing the workflow has available capacity. The available capacity may include available computing resources (processor time, memory, storage), available tenant capacity, available namespace capacity, or any other resource required to increase the number of workers 212.

If the cluster 111 executing the workflow is found 410 to have available capacity, the method 400 may include instructing 412 increased provisioning on the cluster, e.g., provisioning one or more additional workers 212. The number of workers may increase in proportion to the number of workflows with predicted timeouts and the magnitude of the timeouts.

Instructing 412 increased provisioning may include generating a notification that is transmitted to an administrator or other human operator that instructs the provisioning of one or more additional workers. Instructing 412 increased provisioning may include instructing the orchestrator 106 to provision one or more additional workers 212, which the orchestrator 106 may implement without human intervention. Alternatively, a KUBERNETES Kubelet or master implementing the cluster 111 may be instructed to provision the one or more additional workers.

If the cluster is found 410 not to have additional capacity, the method 400 may include instructing 414 increase in the number of clusters 111 executing workers 212. Instructing 414 increased provisioning of clusters 111 may include generating a notification that is transmitted to an administrator or other human operator that instructs the provisioning of one or more additional clusters 111. Instructing 414 provisioning of additional clusters 111 may include instructing the orchestrator 106 to provision one or more additional clusters 111, which the orchestrator 106 may implement without human intervention.

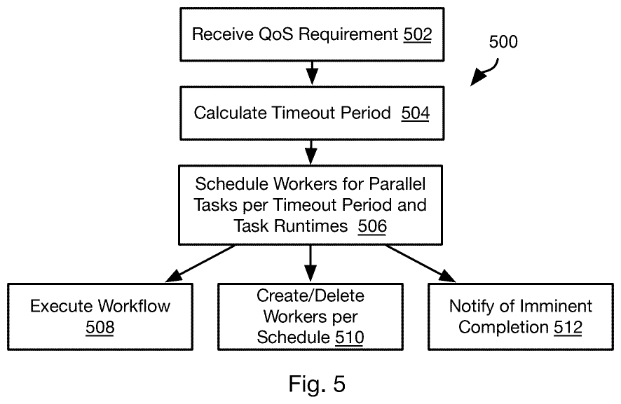

FIG. 5 illustrates a method 500 that may be executed in the network environment 100, such as by the worker management module 214, workflow orchestrator 122, orchestrator 106, or another component. The method 500 may be used to manage the creation and deletion of workers 212. A typical user may request a maximum number of workers 212 or a constant number of workers to achieve maximum parallelization permitted by a workflow. However, simply executing a maximum number of workers 212 may waste power. Likewise, statically allocating workers 212 to a workflow may waste resources when only serial tasks are being performed. The method 500 may be used to achieve a desired QoS for each workflow while reducing the number of workers 212 to save power.

The method may include receiving 502 a QoS requirement for a workflow. The QoS requirement may be in the form of a percentage, e.g., a percentage of the reference workflow runtime for the workflow. The method 500 may include calculating 504 a timeout period for the workflow based on the QoS requirement and the QoS requirement, such as by multiplying the reference workflow runtime by the QoS. The method 500 may then include scheduling 506 workers 212 for parallel tasks according to the timeout period and the task runtimes of the tasks of the workflow. In particular, for each group of parallelizable tasks, the number of workers 212 for each task may be selected such that an estimated runtime of the workflow is within a threshold of the timeout period, e.g., less than 90 percent of the timeout period or less than the timeout period by at least the smallest task runtime of the parallelizable tasks. Accordingly, where the QoS is small and the timeout period is longer than the reference workflow runtime, the number of workers 212 scheduled for one or more groups of parallelizable tasks may be smaller than the number of tasks in the group such that some tasks in the group will be performed serially.

The method 500 may then include executing 508 the workflow on the workers 212. Workers 212 may be created and delete 510 according to the schedule. The number of workers will therefore vary over time in order to achieve the quality of service while also deleting workers 212 that are no longer needed. For example, for a group of parallelizable tasks, workers 212 may be created such that when the tasks begin, the number of workers 212 available to perform the tasks is equal to the number determined at step 506. The group of parallelizable tasks may begin when a preceding task that is required to complete before the group parallelizable tasks may execute. One or more workers 212 created according to the schedule to execute the parallelizable tasks may begin to be created when the preceding task is nearly complete, such as within Y seconds of the task runtime of the preceding task, where Y is the amount of time required to create a worker 212 or some multiple thereof, e.g., a multiple greater than one. When execution of a group of parallelizable tasks is complete, the number of workers 212 may be reduced by deleting workers 212 according to the schedule to a number of workers defined by the schedule for executing tasks of the workflow following the group of parallelizable tasks.

The method 500 may be performed for multiple workflows simultaneously such that workers 212 are created and then deleted according to the schedules for the multiple workflows such that the number of workers 212 that are executing at any given time may be the sum of the number workers defined by the schedules for the multiple workflows at that time.

Using the approach of FIG. 5, users may specify QoS in terms of execution time but do not directly control the number of workers 212 utilized. In this manner, the number of workers 212 may be managed based on need in order to achieve the QoS while taking advantage of opportunities to delete workers 212 when not needed.

In some embodiments, the method 500 may include notifying 512 a user associated with a workflow that completion of a workflow is imminent. For example, when the workflow is Z percent complete, where Z is 80, 90, 95 or some other value. The percent completion of a workflow may be calculated as 100*(current run time)/(estimated runtime), where current run time is the amount of time the workflow has been executing and the estimated runtime is the reference workflow runtime, the timeout period or a function of the timeout period.

Notifying 512 may include transmitting an email, text message, or message according to another modality to the user. In this manner, the user may commence execution of another workflow, prepare to use software instantiated by the workflow, or perform other tasks.

FIG. 6 illustrates an embodiment of a device 600. As shown in FIG. 6, the device 600 processor 610, a memory 620, a storage component 630, an input component 640, an output component 650, a communication interface 660, and a bus 670.

The processor 610, as used herein, means any type of computational circuit that may comprise hardware elements and software elements. The processor 610 may be embodied as a multi-core processor, a single core processor, or a combination of one or more multi-core processors and/or one or more single core processors, a distributed processing system, or the like. The processor 610 may be a Central Processing Unit (CPU)a graphics processing unit (GPU), an accelerated processing unit (APU), an application-specific integrated circuit (ASIC), or another type of processing component.

Memory 620 includes a non-transitory computer readable medium. Memory 620 includes a random-access memory (RAM), a read only memory (ROM), and/or another type of dynamic or static storage device (e.g., a flash memory, a magnetic memory, and/or an optical memory) that stores information and/or instructions for use by processor 610. The memory 620 comprises machine-readable instructions which are executable by the processor 610. These machine-readable instructions when executed by the processor 610 cause the processor 610 to perform one or more method steps of an embodiment described above.

Storage component 630 stores information and/or software related to the operation and use of the device 600. For example, storage component 630 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 640 is configured to receive information, such as user input. For example, the input component 640 may include, but not be limited to, a touch screen display, a keyboard, a keypad, a mouse, a button, a switch, and/or a microphone. Additionally, or alternatively, the input component 640 may include a sensor for sensing information (e.g., a global positioning system (GPS), an accelerometer, a gyroscope, and/or an actuator).

Output component 650 is configured to provide output information from the device 600. For example, the output component 650 may be, but not limited to, a display, a speaker, instructions to an external device, and/or one or more light-emitting diodes (LEDs).

Communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the device 600 and other devices. In other words, the standard of the communication interface 660 is not limited.

The bus 670 acts as an interconnect between the processor 610, the memory 620, the storage component 630, the input component 640, the output component 650, and the communication interface 660 of the device 600. The bus 670 may include a wired interconnection or a wireless interconnection.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600. Further, one or more method steps described in any of the embodiments may be performed utilizing a plurality of devices 600 in communication with one another.

In a first example embodiment, a method includes:
providing a network environment including one or more computing nodes;
providing, to the network environment, a workflow including a plurality of tasks, the plurality of tasks including one or more groups of parallelizable tasks;
receiving, by the network environment, a quality of service for the workflow; and
executing, by the network environment, the workflow with workers from a worker pool while creating workers to execute a number of tasks of the one or more groups of parallelizable tasks in parallel effective to achieve the quality of service and while deleting workers when not executing the one or more groups of parallelizable tasks.

In a second example embodiment of the first example embodiment, the workers are containers.

In a third example embodiment of the first example embodiment, the quality of service is defined as a ratio with respect to a reference workflow runtime of the workflow.

In a fourth example embodiment of the third example embodiment, the method further includes selecting a number of workers during execution such that the number of workers decreases with increase in the ratio.

In a fifth example embodiment of the third example embodiment, the plurality of tasks of the workflow are arranged in a directed acyclic graph defining the one or more groups of parallelizable tasks and ordering of tasks of the plurality of tasks.

In a sixth example embodiment of the first example embodiment, a number of workers varies over time as a function of task runtimes of the plurality of tasks and the one or more groups of parallelizable tasks.

In a seventh example embodiment of the first example embodiment, the workflow is part of a lifecycle of a software component.

In an eighth example embodiment of the seventh example embodiment, the workflow at least one of creates, upgrades, or deletes the software component.

In a ninth example embodiment, a method includes:
providing a network environment including one or more computing nodes;
providing a worker pool executing in the network environment;
providing one or more queues executing in the network environment;
adding, by the network environment, a plurality of tasks of one or more workflows to the one or more queues, each workflow of the one or more workflows having a timeout period;
executing, by the network environment, the plurality of tasks from the one or more queues;
calculating, by the network environment, an estimated time of completion for each workflow of the one or more workflows according to task runtimes of the plurality of tasks and a number of workers in the worker pool; and
producing, by the network environment, an output according to the estimated time of completion for each workflow of the one or more workflows.

In a tenth example embodiment of the ninth example embodiment, the method further includes:
determining that (a) the estimated time of completion of a first workflow of the one or more workflows exceeds a timeout period for the first workflow; and
in response to (a), instructing increasing provisioning for the worker pool.

In an eleventh example embodiment of the ninth example embodiment, instructing increasing provisioning for the worker pool comprises increasing namespace capacity.

In a twelfth example embodiment of the ninth example embodiment, instructing increasing provisioning for the worker pool comprises increasing a number of clusters executing the worker pool.

In a thirteenth example embodiment of the ninth example embodiment, instructing increasing provisioning for the worker pool comprises generating a notification to a human user.

In a fourteenth example embodiment of the ninth example embodiment, the method further includes determining the timeout period according to a quality of service.

In a fifteenth example embodiment of the ninth example embodiment, the workers of the worker pool are containers.

In a sixteenth example embodiment of the ninth example embodiment, the output includes the estimated time of completion for each workflow of the one or more workflows.

In a seventeenth example embodiment of the ninth example embodiment, the output includes a notification to a human user indicating that completion of a workflow of the one more workflows is imminent.

In an eighteenth example embodiment, a system includes:
a network environment comprising a plurality of computing devices and a network connected to the plurality of computing devices, the network environment configured to:
provide a worker pool;
receive a workflow including a plurality of tasks, the plurality of tasks including one or more groups of parallelizable tasks;
receive a quality of service for the workflow; and
execute the workflow with workers from the worker pool while creating workers to execute a number of the one or more groups of parallelizable tasks in parallel effective to achieve the quality of service and while deleting workers when not executing the one or more groups of parallelizable tasks.

In a nineteenth example embodiment of the eighteenth example embodiment, the workers are containers.

In a twentieth example embodiment of the eighteenth example embodiment, the quality of service is defined as a ratio with respect to a reference workflow runtime of the workflow.

1. A method comprising:
providing a network environment including one or more computing nodes;
providing, to the network environment, a workflow including a plurality of tasks, the plurality of tasks including one or more groups of parallelizable tasks;
receiving, by the network environment, a quality of service for the workflow; and
executing, by the network environment, the workflow with workers from a worker pool while creating workers to execute a number of tasks of the one or more groups of parallelizable tasks in parallel effective to achieve the quality of service and while deleting workers when not executing the one or more groups of parallelizable tasks.

2. The method of claim 1, wherein the workers are containers.

3. The method of claim 1, wherein the quality of service is defined as a ratio with respect to a reference workflow runtime of the workflow.

4. The method of claim 3, further comprising selecting a number of workers during execution such that the number of workers decreases with increase in the ratio.

5. The method of claim 3, wherein the plurality of tasks of the workflow are arranged in a directed acyclic graph defining the one or more groups of parallelizable tasks and ordering of tasks of the plurality of tasks.

6. The method of claim 1, wherein a number of workers varies over time as a function of task runtimes of the plurality of tasks and the one or more groups of parallelizable tasks.

7. The method of claim 1, wherein the workflow is part of a lifecycle of a software component.

8. The method of claim 7, wherein the workflow at least one of creates, upgrades, or deletes the software component.

9. A method comprising:
providing a network environment including one or more computing nodes;
providing a worker pool executing in the network environment;
providing one or more queues executing in the network environment;
adding, by the network environment, a plurality of tasks of one or more workflows to the one or more queues, each workflow of the one or more workflows having a timeout period;
executing, by the network environment, the plurality of tasks from the one or more queues;
calculating, by the network environment, an estimated time of completion for each workflow of the one or more workflows according to task runtimes of the plurality of tasks and a number of workers in the worker pool; and
producing, by the network environment, an output according to the estimated time of completion for each workflow of the one or more workflows.

10. The method of claim 9, further comprising:
determining that (a) the estimated time of completion of a first workflow of the one or more workflows exceeds a timeout period for the first workflow; and
in response to (a), instructing increasing provisioning for the worker pool.

11. The method of claim 9, wherein instructing increasing provisioning for the worker pool comprises increasing namespace capacity.

12. The method of claim 9, wherein instructing increasing provisioning for the worker pool comprises increasing a number of clusters executing the worker pool.

13. The method of claim 9, wherein instructing increasing provisioning for the worker pool comprises generating a notification to a human user.

14. The method of claim 9, further comprising determining the timeout period according to a quality of service.

15. The method of claim 9, wherein the workers of the worker pool are containers.

16. The method of claim 9, wherein the output includes the estimated time of completion for each workflow of the one or more workflows.

17. The method of claim 9, wherein the output includes a notification to a human user indicating that completion of a workflow of the one more workflows is imminent.

18. A system comprising:
a network environment comprising a plurality of computing devices and a network connected to the plurality of computing devices, the network environment configured to:
provide a worker pool;
receive a workflow including a plurality of tasks, the plurality of tasks including one or more groups of parallelizable tasks;
receive a quality of service for the workflow; and
execute the workflow with workers from the worker pool while creating workers to execute a number of the one or more groups of parallelizable tasks in parallel effective to achieve the quality of service and while deleting workers when not executing the one or more groups of parallelizable tasks.

19. The system of claim 18, wherein the workers are containers.

20. The system of claim 18, wherein the quality of service is defined as a ratio with respect to a reference workflow runtime of the workflow.
